(19) United States
(12) Patent Application Publication
(10) Pub. No.: US 2007/0033193 A1
(43) Pub. Date: Feb. 8, 2007

(54) Method for remote controlling of www-browser

(75) Inventor: Aatu Koskensilta, Tampere (FI)

Correspondence Address: VENABLE LLP, P.O. BOX 34385, WASHINGTON, DC, 20043-9998, US

(73) Assignee: XORTEC OY, Tampere (FI)

(21) Appl. No.: 10/571,916

(22) PCT Filed: Aug. 8, 2004
(86) PCT No.: PCT/FI04/00472

§ 371 Date: Mar. 15, 2006

(30) Foreign Application Priority Data
Sep. 22, 2003 (FI) 20031358

(51) Int. Cl. G06F 17/30

(52) U.S. Cl. 707/10

(57) ABSTRACT

A method for remote controlling a www-browser, whereby a user is operating with an HTTP-server at his/her disposal by using his/her own www-browser for browsing various sources accessible over a communication network for documents, such that one or more clients in communication with the server have their browsers updated to display each document chosen by the user with his/her browser to be displayed. When the document chosen includes a hypertext document, indicated particularly by a URL-address, instead of an actual server response containing the URL-address, the user's browser is supplied with output from a separate script in communication with the user's server and operating as a filter. The output is externally equivalent to the desired hypertext document identified by the URL-address given to the filter script as a parameter, such that following a hypertext link included therein results in a request for the filter script with an address contained in the hypertext link as its parameter.

The invention relates to a method for remote controlling a www-browser, whereby a user is operating with an HTTP-server at his/her disposal by using his/her own www-browser for browsing various sources accessible over the internet, intranet or a similar communications network for documents of his/her choice, such that one or more clients in communication with the server have their browsers updated to display each document chosen by the user with his/her browser to be displayed.

International patent publication WO 01/05093 discloses a method, whereby the user is capable of directing the www-browsers of selected listeners to display documents from various sources accessible by his/her www-browser e.g. over the internet or intranet. The discussed method covers e.g. applications, in which the controller is in advance able to prepare lists of URL-addresses (Universal Resource Location) specifying the way and route of retrieving documents to be displayed.

However, the above-cited publication does not describe exactly how the administrator chooses the URL-address intended to be displayed by a client's browser. One convenient way of doing this would be to allow the user to browse through www-pages in a normal fashion, such that the client's browser would be updated to always show the same page as the user's browser. However, due to the security architecture of browsers, this cannot be achieved in traditional methods by just using a www-browser and scripting languages in a normal manner. By means of the above-cited method, a function as mentioned above is nevertheless feasible with certain limitations, without installing extensions to the user's or client's browser, not to mention the use of Java or other such external programming language. The method is based only on the normal operation of a www-browser and on the characteristic capability of an HTTP-server to create dynamic pages in such a way that hypertext documents, especially those to be displayed in the controller's browser, will be processed in a server at his/her disposal, such that the following hypertext links present therein results in a request for the server to modify a document designated by a particular hypertext link and then to return it to the user's browser for browsing and displaying, and then further to supply clients' browsers with a command to retrieve the document either from its original source, if that is accessible by the clients' browsers, or from a database (or a similar storage system) in the user's server, which is used for storing documents not accessible by the clients' browsers.

Other methods enabling a user to reflect his/her www-browsing to clients, such as e.g. services marketed under titles “Netmeeting” or “WebEx”, are based on the fact that, by means of separate software, it is possible to demonstrate the process of any application program for the participants of a presentation or a conference, such that they will be able to either monitor the user's activities or to operate the functions of applications assigned to them in accordance with the discussed methods. These methods require specific operating systems and software in order to function, as well as often also special network configuration, nor is the operation thereof possible solely by means of a www-browser and an http-server.

It is an object of the present invention to provide a decisive improvement regarding the above problems and thereby to raise substantially the available prior art. In order to fulfil this objective, a method of the invention is principally characterized in that, when the document chosen to be displayed comprises a hypertext document, such as an html-page or the like, indicated particularly by a URL-address, instead of an actual server response containing the discussed URL-address, the user's browser is supplied with an output from a separate script in communication with the user's server and operating as a filter, said output being a response externally similar to the desired hypertext document identified by the URL-address given to the filter script as a parameter, such that the following of a hypertext link included therein results in a request for the filter script with an address contained in the discussed hypertext link as its parameter.

The present invention provides a method, whereby the use of e.g. the foregoing (WO 01/05093) method can be significantly facilitated and made more reliable. The method enables the user in a presentation to employ normal browsing techniques (to follow hypertext links) in order to browse www-pages in such a way that the clients' browsers repeat the user's browsing activities concretely in real time. The method differs considerably from other currently employed remote control methods for computers, especially in the sense that it can be totally implemented solely by means of a basic www-browser mechanism and a server adhering to an HTTP-protocol. On the other hand, as pointed out above, other available remote control methods require support provided by separate softwares or browser extensions (appletts, script language programs, or the like) both for the user's system and usually also for the clients' systems. As a result, such methods are highly complicated in terms of technology and require special expertise in order to successfully organise presentations or conferences.

Regarding the use of a method of the present invention, the client will not be granting the user any authority over his/her own system, that is not normally granted to the maker of some unfamiliar www-page, anyway. This is by virtue of the fact that, from the client's point of view, the method in technical terms is totally equivalent to his/her browsing the web for information presented by the user. Another result of this is that, if the client is capable of browsing through sets of www-pages, he/she shall also be a capable participant in a presentation performed by means of the method. In this respect as well, other methods currently available for a similar objective generally impose considerably more extensive technical requirements (allowing some protocol, Java operating authorization, etc.) on the clients' interfaces.

A benefit provided by the method both for a user and for clients is evident e.g. in the following occasions:
The user wishes to present his/her clients with some information not found in his/her previously prepared agendas. With the method, the user is able to find the information quickly in some set of www-pages and visualise it immediately for the clients.
The user wishes to present his/her clients with an extensive amount of information, the choices made therefrom depending on the interests and reactions of clients.
The user wishes to display some set of www-pages (e.g. a databank, archives, technical documentation). With the method, the user is able to browse through the set of pages in a normal manner and to describe subjects and data processing procedures by following hypertext links indicating connections.

Other preferred applications for a method of the invention are set forth in dependent claims directed thereto.

The invention will be described in detail in the following specification while making reference to the accompanying drawings, in which

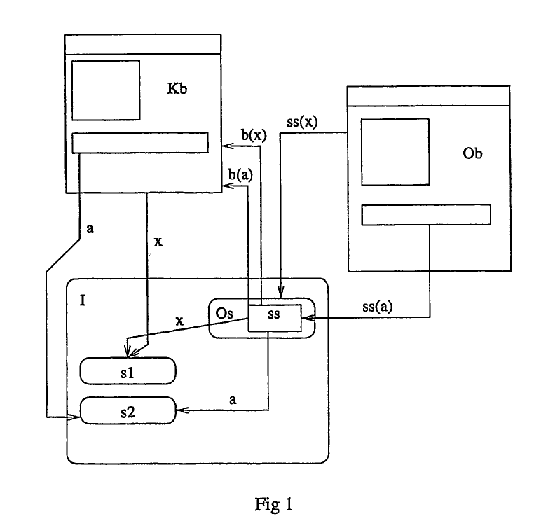

FIG. 1 shows one general operating principle for a method of the invention, and

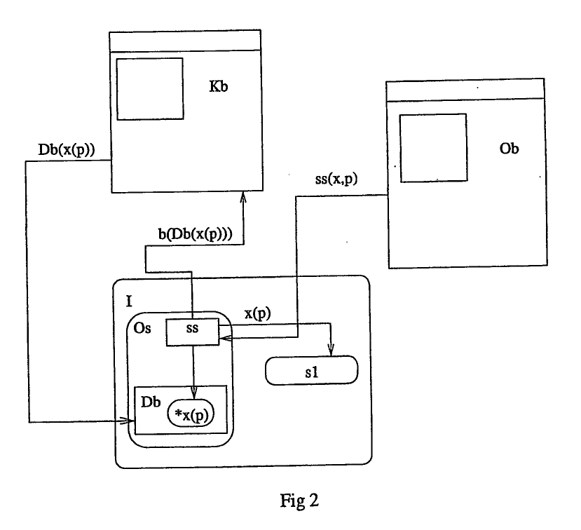

FIG. 2 shows by way of an example the method as applied in the context of such pages whose accessibility or contents depend on parameters to be supplied, such as e.g. on the information of a questionnaire.

The invention relates to a method for remote controlling a www-browser, whereby a user is operating with an HTTP-server Os at his/her disposal by using his/her own www-browser Ob for browsing various sources accessible over the internet, intranet or a similar communications network for documents of his/her choice, such that one or more clients in communication with the server Os have their browsers Kb updated to display each document chosen by the user with his/her browser Ob to be displayed. When the document chosen to be displayed comprises a hypertext document, such as an html-page or the like, indicated particularly by a URL-address x, instead of an actual server response containing the discussed URL-address, the user's browser Ob is supplied with an output ss(x) from a separate script ss in communication with the user's server Os and operating as a filter, said output being a response externally equivalent to the desired hypertext document identified by the URL-address x given to the filter script ss as a parameter, such that the following of a hypertext link included therein results in a request for the filter script ss with an address contained in the discussed hypertext link as its parameter. Thus, e.g., in reference to the general method operating principle shown in FIG. 1, an original link a is replaced in the filtered page with a link ss(a), as described above.

The filter script ss, functioning as described above, can be e.g. a normal CGI-type script on some conventional http-server, but there are also other options for its implementation. For example, if there are two web identifiers (domain names) allocated for an http-server, the server can be configured in such a way that, when it is referred to by one of the web identifiers, it will “imitate” some other server (functioning like a filter script described hereinafter), which is identified by supplying it with necessary information, for example by way of a cookie or some other parameter passing method. This is equivalent to the condition that the URL-address parameter to be given to the filter script is supplied directly as a URL, which appears to refer to a server identified by the other web identifier.

After the filter script ss has been supplied with a desired URL-address x as a parameter, a hypertext document indicated by the discussed address is first retrieved for processing, whereafter the filter script ss is used to replace hypertext links a appearing in the document with links ss(a) which define a request for the filter script ss with the discussed hypertext link a given as an argument therefor, and/or relative references, such as URL-addresses, present in picture elements, cascading stylesheets, and/or the like, are converted into absolute references.

The filter script ss (or a second script associated therewith) must naturally handle also the filtering of cascading stylesheets in such a way that the URL-addresses (e.g. a URL-address for a background image) appearing therein are indeed absolute.

In a further preferred embodiment of the method, the filter script ss is used in the first place to process forms embedded in a desired hypertext document, such that the handler defined therein is replaced with a handler ss(x, p) supplied with information p of the form, and secondly the original information, such as the original handler, is embedded as hidden fields concealed in the filtered form.

In a particular reference to the preferred embodiment shown in FIG. 2, when the user chooses, e.g. by following a hypertext link, a given page to be displayed from the URL-address x, which depends on the parameters p, including input data for a form; cookies, user identification data or other such information defining the contents or accessibility of a document indicated by the above-discussed address x, this document shall be retrieved by the filter script ss from a given server s1, in which the x(p)-designated document is located, by supplying the filter script ss with p as a parameter thereof in connection with an http-request. This is followed by filtering this page for the user's browser Ob as shown in the embodiment of FIG. 1, as well as separately also for clients to provide a document *x(p) which is stored in a database Db or other such system for the clients' browsers Kb by having all its relative addresses converted to absolute ones and documents containing other elements processed in a corresponding manner, e.g. as described in the following segments of this specification. At this point, the filter script ss additionally issues to the clients' browsers Kb a command b(Db(x(p))) to display the document *x(p) by retrieving it from the operator's server Os from the database Db by means of a normal http-protocol. In the operator's server Os, the subsequently required URL-addresses will be mapped by a given script or other similar application to pages stored in a database.

Hence, the documents *x(p) to be visualised for clients must be filtered in such a way that various sub-components—such as sub-documents embedded in a document by means of a frame-tag, cascading stylesheets, etc.—shall be retrieved from a database, in which they are stored, as soon as the user's browser, after receiving the filtered documents, commences to retrieve them by presenting requests to the screen script ss.

Moreover, the mode of operation shown in FIG. 2 enables naturally the filter script ss to edit forms embedded in www-pages, such that the original handler x defined therein is replaced with a new handler ss(x, p), which is then supplied with information p of the form. The original information of the form, such as the original handler and e.g. the transmission method for the form's information, can be embedded in the filtered form as hidden fields causing no distraction to the user. Executed this way, the method can also be used as the user performs www-based database retrievals, searches using search engines, etc., the method making it possible for clients to monitor said functions subject to the user's approval. It is important that the client's/clients' browser Kb not be supplied with information given by the user to the discussed form, as such information may contain passwords, user identifications or other data naturally confidential and not to be disclosed to others.

Consequently, the method of FIG. 2 also makes it possible for the user to browse through password-protected sets of pages, which are protected with identification protocols included in an http-protocol in such a way that the clients are able to monitor this, yet are unable to learn passwords, nor can themselves start browsing through possibly delicate or important material. This can be achieved in such a way that, when coming across a password-protected set of pages, the filter script ss transmits to the user's browser a page, in which this identification data is requested and which, as soon as the data is supplied, sends said data to the filter script ss which is now capable of retrieving the required page by supplying the server containing it with the identification data delivered thereto. Passwords for various security domains can be recorded in a database in such a way that, after supplying a given security domain once with the data, the user need not give it a second time.

The method of FIG. 2 can also be used whenever the user browses sets of pages using cookies which generally contain e.g. login information or other such information, which is why the simplified operating patterns shown e.g. in FIG. 1 are not sufficient for the reason that, because the clients' browsers Kb supply the servers with cookies other than those of the user's browser, the pages seen by the user and the clients are different from each other. In order to rectify this, the filter script ss stores, e.g. in a database Db, the cookies it has received from the servers and also sends the same along with requests as parameters p to the servers and stores the pages received in a filtered form for the clients, as described above, and instructs the clients' browsers to retrieve the pages stored in the database.

Cookies may be also be used in scripts embedded in a page. The scripts are filtered e.g. in such a way that all references to various objects containing browser information will be replaced with references to an object, which is created by a script embedded in the page by the filter script ss. Such objects only include information that is allowable for a script coming from a given server. Such information includes the very cookies which have arrived from this particular server.

Another preferred application of the method is to organise e.g. various meetings or interactive presentations in such a fashion that the clients' browsers Kb also operate, whenever necessary and in a limited manner, the same way as the user's browser Ob, and the user's browser Ob functions the same way as the clients' browsers Kb in the sense that it is always updated to display the view of relevant operating browsers.

In a further preferred application of the method, combined with the above-described implementation, it is possible for several persons to e.g. edit and update sets of www-pages in collaboration, such that the filtered pages to be produced for the user's browser are by means of JavaScript and/or other tools provided with a capability of changing the contents of a page in such a way that the changes will be updated for viewing by clients and other users.

In yet another preferred application, the user's interface can be used for disabling the linkage of one or more clients' browser Kb to the user's browser Ob, particularly to make sure that the view on each client's www-browser is in all cases only supplied with controlled documentation instead of e.g. www-pages which have become outdated or irrelevant regarding the contents thereof.

As a further preferred feature, the user's interface provides a possibility for the user to keep open a larger number of browsing windows in the process of browsing documents and to swich from window to window in such a way that the client is always provided with a view of the page which the user has in the active window at that time.

Thus, a foundation of the method is that the user's browsing activities are “rerouted” through an HTTP-server containing pages and scripts required by him/her. By virtue of this, the user's browsing activities can also be readily conveyed to a client's browser, e.g. as described in the above-cited method (WO 01/05093). It is also possible to employ the present invention in combination with any method capable of sending instructions from a user's server to clients' browsers.

On the other hand, a practical application of the method requires utmost care not to give a chance to a so-called cross site scripting attacks. Such an attack refers for example to a situation, in which a given page has embedded therein some malicious JavaScript code which issues commands to a server. Normally, a script is only-able to communicate with that server which has delivered the page it is embedded in, and therefore it is impossible for the script to launch an attack against other servers or to exploit information received from elsewhere. However, if a script resides on a page produced by means of the filter script ss, it has a right, as far as the browser is concerned, to communicate with the filter-script containing server which may have located therein information regarding user interfaces prepared for easier use of the method and possibly passwords. Poorly executed, the method might facilitate malicious actions, e.g. deletion of files, destruction of prepared presentations, etc.

In this context, however, it is possible with a minor static analysis to disable a certain set of potentially hostile actions performed by scripts. This cannot be done in general extent, but when certain constructions used by scripts are simply filtered out, it is possible to ensure that the remaining code is acceptable. The remaining subset is sufficient for generally employed purposes. Commonly employed properties include e.g.:
opening of new browsing windows,
execution of minor graphic details, e.g. image is changed by placing a mouse on top of it, and
automated checking of form information.

Excluded properties include generally e.g.:
execution of arbitrary code (eval, etc.). This can also be done by replacing eval-function calls with eval′-function calls, wherein the eval′-function applies the presently described principles to examine a code assigned thereto and thus proceeds to process a safe code only,
sending of arbitrary HTTP-requests to a source server, and
functions referring to script variables of a window that has opened the script-containing window,

It is obvious that the invention is not limited to the applications illustrated or described above, but can be varied within the basic inventive concept as required by any given practical applications and demands. Hence, particularly in view of increasing usability of the method, e.g. the following expansions are also feasible
Server has a capability of recording the user's browsing activities to give him/her a chance, if desirable at some later occasion, to reproduce them directly for some other client.
The script language transaction handler of a JavaScript (or the like) browser can be used for conveying also other browsing activities than just following hypertext links to be displayed by the browser. For example, it is possible at certain intervals to change the position of a mouse indicator or to display the input procedures of text imput fields.

1. A method for remote controlling a www-browser, whereby a user is operating an HTTP-server at his/her disposal by using his/her own www-browser for browsing various sources accessible over the Internet, intranet or similar communications network for documents of his/her choice, such that one or more clients in communication with the server have their browsers updated to display each document chosen in various ways by the user with his/her browser to be displayed, wherein whereby using solely standardized Internet protocols to control one or more clients' browsers, said browsers being without additionals, by a www-browser, a user and his/her client or clients, in case the user so permits, are equally operating with an HTTP-server at his/her/their disposal by using his/her/their own www-browser/browsers for browsing various sources accessible over Internet, intranet or similar communications network for documents of his/her choice, such that the user and the client/clients in communication with the server have his/her/their browser/browsers updated actively by themselves to display each document chosen by the user with his/her browser, so that, when the document chosen to be displayed comprises a hypertext document, such as an html-page or the like, indicated particularly by a URL-address, instead of an actual server response containing the discussed URL-address, the user's browser is supplied with an output (ss(x)) or a handler, from separate script in communication with the user's server, invoked by referring to the user's server by a specially allocated domain name, operating as a filter, said output being a response externally equivalent to the desired hypertext document identified by the URL-address or by said address and additional retrieval information given to the filter script as a parameter, such that the following of hypertext links, or submitting forms or in some other way transiting to another page results in a request for the filter script by using as its parameter an address contained in the discussed hypertext link or in some other retrieval information.

2. The method according to claim 1, wherein after the filter script has been supplied with a desired URL-address as a parameter, a hypertext document indicated by the discussed address is first retrieved for processing, whereafter the filter script is used to replace hypertext links a appearing in the document with links which define a request for the filter script with the discussed hypertext link allocated as an argument therefor, and/or relative references, such as URL-addresses, present in picture elements, cascading style sheets, and/or the like, are converted into absolute references.

3. The method according to claim 1, wherein when a document depends on a given parameter, such as a cookie, user identification data, values of hidden fields on a form, and/or the like, the filter script is used to retrieve the original document from a server containing it by giving it the discussed parameter as a parameter for an http-request retrieving the discussed document and by storing this document, after screening it for clients to make it externally equivalent to the original document, in a database or the like, the browser of one or more clients being directed to display it therefrom.

4. The method according to claim 2, wherein the filter script is used in the first place to process forms embedded in a desired hypertext document, such that the handler defined therein is replaced with a handler supplied with information of the form, and secondly the original information is embedded as hidden fields in the filtered form.

5. The method according to claim 1, wherein the user interface is used to enable disconnecting the linkage of one or more clients' browser to the user's browser, especially for making sure that the display of each client's www-browser is in all instances only supplied with controlled documentation.

6. The method according to claim 1, wherein the user interface is used to enable the user to keep open a plurality of browsing windows in the process of browsing documentation and to move from window to window in such a way that each client is always provided with a view of the page which the user has in an active window at that time.

7. The method according to claim 1, wherein the scripts present in hypertext documents to be browsed are filtered in such a way that all references to various objects containing information of a www-browser are replaced with references to an object, which is created by a script embedded in a processed page by the filter script.

8. A The method according to claim 1, wherein the scripts embedded in www-pages subject to browsing are allowed to have e.g. the following capabilities of:
opening new browsing windows,
executing minor graphic details, such as replacing a picture with other upon placing the mouse on top of it, and
automatically checking information presented in forms.

9. The method according to claim 7, wherein the scripts emedded in www-pages subject to browsing are disallowed to have e.g. the following capabilities of:
executing an arbitrary code (eval, etc.),
sending arbitrary HTTP-requests to a source server, and
functions relating to the script variables of a window that has opened the script-containing window.

10. The method according to claim 1, wherein operation of the user interface involved in utilization of the method enables one or more clients to serve as an active operator supplying documents to other participants.
